(19) United States
(12) Patent Application Publication
(10) Pub. No.: US 2008/0204403 A1
(43) Pub. Date: Aug. 28, 2008

(54) Transaction System, Method of Verifying a User's Authorisation to Carry Out a Transaction and Cash Dispenser

(76) Inventor: Martijn Martinus Cornelis Verbeek, Monster (NL)

Correspondence Address: BROOKS KUSHMAN P.C., 1000 TOWN CENTER, TWENTY-SECOND FLOOR, SOUTHFIELD, MI, 48075, US

(21) Appl. No.: 11/917,563

(22) PCT Filed: Jun. 15, 2006
(86) PCT No.: PCT/NL2006/050137

§ 371 Date: Dec. 14, 2007

(30) Foreign Application Priority Data
Jun. 16, 2005 (NL) 1029264

(51) Int. Cl. G09G 5/00

(52) U.S. Cl. 345/156

(57) ABSTRACT

A transaction system comprises an input device for inputting of data by a user, and at least one screen which is visible during use of the input device. The system is arranged for displaying an area located at least partially behind a user facing the input device on the screen at least during use of the input device. The transaction system comprises at least one camera directed at said area as well as a device for displaying images recorded by at least one of the cameras at least partially on the screen.

The invention relates to a transaction system comprising

an input device for inputting of data by a user, and

at least one screen which is visible during use of the input device, said system being arranged for displaying an area located at least partially behind a user facing the input device on the screen at least during use of the input device.

The invention further relates to a method for verifying the transaction authority of a user, comprising the steps of

providing an input device for inputting data for verifying a user's authority, and

enabling the user to observe an area located at least partially behind a user on a screen at least during inputting of data.

The invention also relates to an automated teller machine.

Respective examples of such a transaction system, method and automated teller machine are known. NL-C-1019884 discloses an automated teller machine provided with reflective elements, which function to enable the user of the automated teller machine to observe what takes place behind him or her. A substantially unobstructed view to the rear is obtained by installing smooth, reflective or mirroring surfaces beside and above the automated teller machine.

A problem of the known system is that the user needs to position himself or herself precisely with respect to the automated teller machine, and that mirrors installed on more than one side of the automated teller machine are required in order to provide the user with a good view of the area behind him. The latter in turn requires the user to divide his attention over the various mirrors.

The object of the invention is to provide a transaction system, a method and an automated teller machine of the above-described type which are more suitable for providing a full view of the area behind the user within the user's field of vision during the inputting of confidential data.

This object is accomplished by the transaction system according to the invention, which is characterised in that the transaction system comprises at least one camera directed at said area and a device for displaying images recorded by at least one of the cameras at least partially on the screen.

Since the system comprises a device for displaying images recorded by the camera or cameras on the screen, use can be made of a diffusely reflective or an active light-emitting screen. As a result, the image being perceived is largely independent of the user's angle of view. The use of a camera for recording images makes it possible to display the entire relevant area within the user's narrow field of vision near the input device.

It is noted that a system comprising a service provider station and a customer station is known from US 2003/0179290. The customer station is provided with a camera and a display unit. While the customer is waiting for a reaction from the service provider, the signal from the camera at the customer station can be relayed to the display unit at the same station, so that the customer sees himself or herself (as well as perhaps a portion of the area behind him or her) while a transaction is in progress.

Said system is thus not arranged for displaying an area located at least partially behind a user facing the input device on the screen, at least not during use of the input device.

In one embodiment the system comprises a device for communicating images recorded by at least one of the cameras directed at the area to a central station present at a location remote from the system.

This makes remote monitoring possible. In addition, this makes it possible to record an image of the user while approaching the system.

In a variant of this embodiment, the system is arranged both for displaying images recorded by a camera directed at said area at least partially on the screen and for communicating said images to said remote central station.

This variant makes advantageous use of a camera that will generally be present already in order to give the user a greater sense of security. The user is shown the same image as the image that is communicated to the central station. This in turn gives the user of the system a sense of being in control over his security while inputting (secret) data. This leads to a safer situation and a greater sense of security. While inputting data, the user is aware of the existence of the camera, he knows that images are being recorded and which images are concerned.

In one embodiment the system is arranged for displaying images recorded by a camera directed at said area at least partially on a display screen and at the same time displaying data relating to a transaction on the same display screen.

Thus, existing infrastructure for carrying out transactions is utilised in a relatively efficient manner for giving the user of the system a greater sense of security.

In a preferred variant of this embodiment, the system is arranged for displaying images recorded by a camera directed at the area on the display screen as a background image and at the same time displaying data relating to the transactions on the foreground, superimposed over the background image.

Thus, the available display screen area is utilised in an efficient manner. In addition, the user need not take his eyes off the data relating to the transaction in order to be able to retain a good view of his or her surroundings.

In one embodiment, at least one of the cameras directed at said area is integrated in an automated teller machine, preferably a wall-mounted automated teller machine.

This is a relatively efficient and inexpensive way of implementing the system. More in particular, it is generally not necessary to install a separate vandal-proof camera near the system. Because of its nature, a wall-mounted automated teller machine is vertically oriented, so that it will be easy to direct the camera or cameras at the area behind the user.

According to another aspect, the method according to the invention is characterised by the recording of at least one image of said area by means of at least one camera and displaying the image recorded by the camera on the screen.

Thus the method has the same advantage as the above-described transaction system according to the invention, which is preferably used for implementing the method.

According to another aspect, the invention provides an automated teller machine provided with a transaction system according to the invention.

Preferably, the screen is integrated in a panel of the automated teller machine.

The advantage of this is that the user need not look away from the automated teller machine in order to view the area behind him.

The invention will be explained in more detail with reference to the appended drawings, in which:

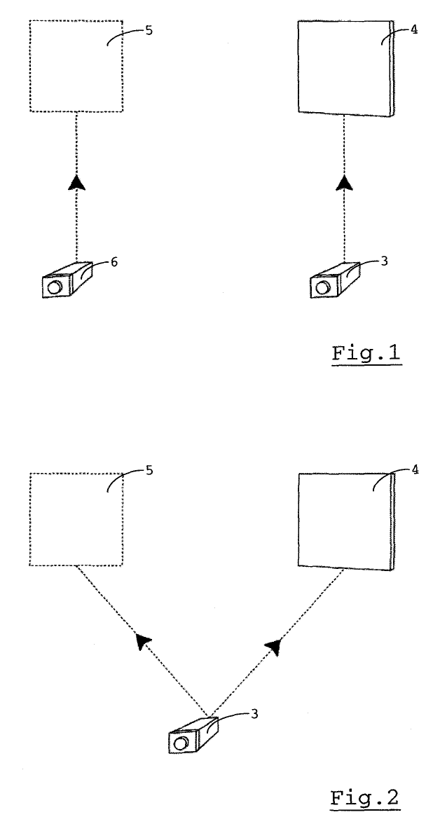

FIG. 1 is a schematic view of a first principle design of a camera system for use in a transaction system;

FIG. 2 is a schematic view of a second principle design of a camera system for use in a transaction system;

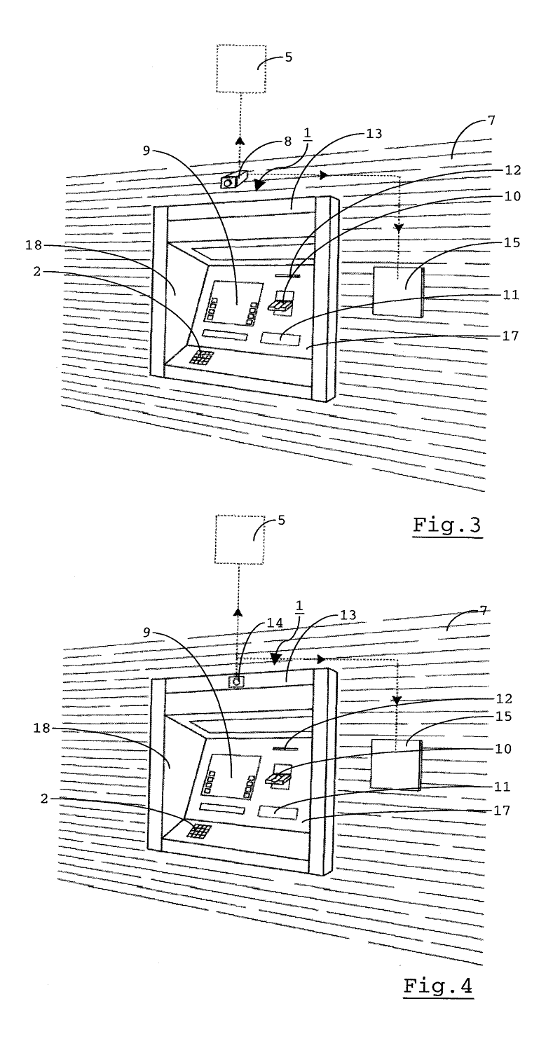

FIG. 3 is a schematic view of an automated teller machine provided with a camera system according to the principle of FIG. 2 and a screen disposed beside the automated teller machine;

FIG. 4 is a schematic view of an automated teller machine provided with a second variant of a camera system according to the principle of FIG. 2 and a screen disposed beside the automated teller machine;

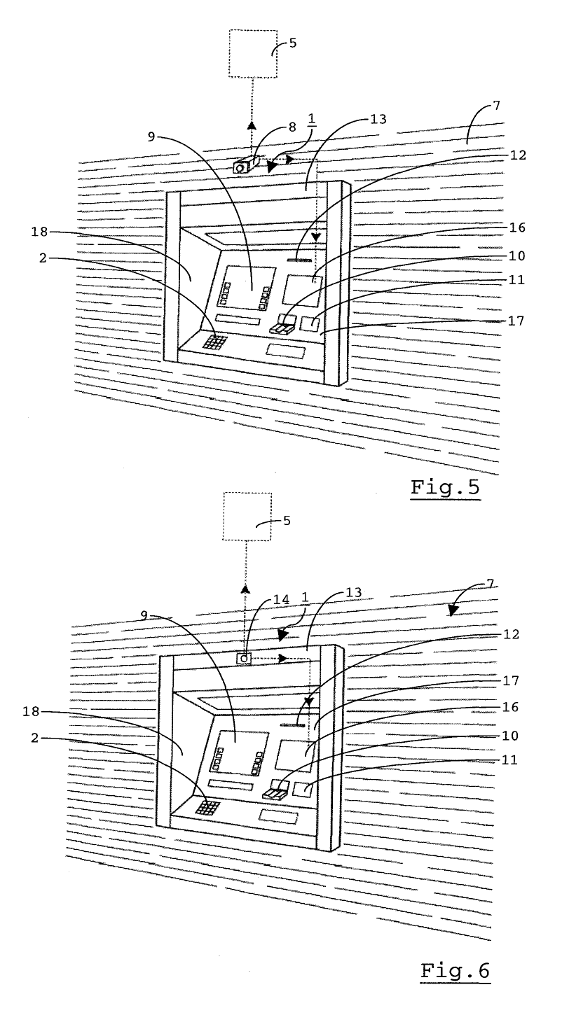

FIG. 5 is a schematic view of an automated teller machine provided with a camera system according to the principle of FIG. 2 and a screen disposed beside the automated teller machine;

FIG. 6 is a schematic view of an automated teller machine provided with a second variant of a camera system according to the principle of FIG. 2 and a screen built into a panel of the automated teller machine;

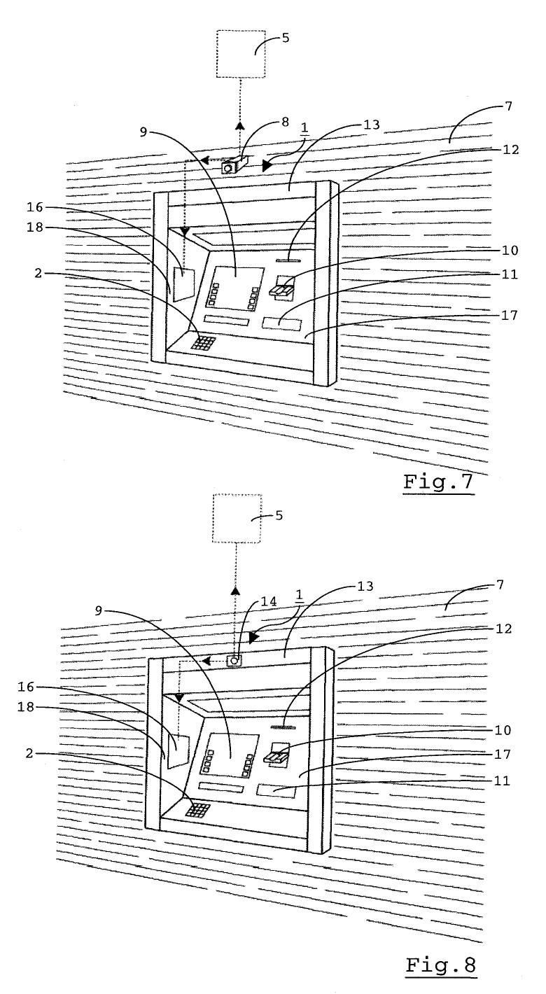

FIG. 7 is a schematic view of an automated teller machine provided with a third variant of a camera system according to the principle of FIG. 2 and a screen built into a panel of the automated teller machine;

FIG. 8 is a schematic view of an automated teller machine provided with a fourth variant of a camera system according to the principle of FIG. 2 and a screen built into a panel of the automated teller machine;

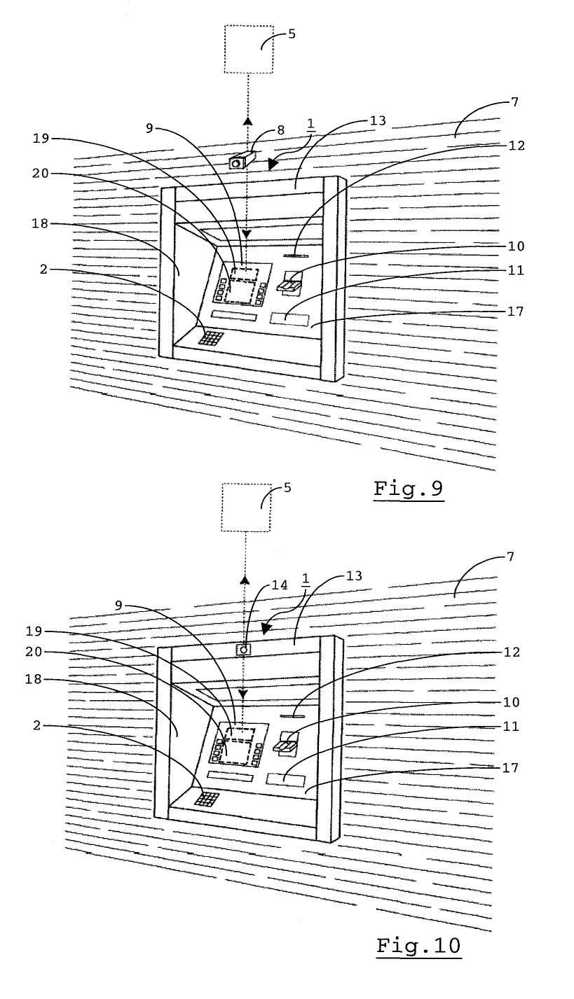

FIG. 9 is a schematic view of an automated teller machine provided with a camera system according to the principle of FIG. 2 and a display screen that is divided into two areas; and

FIG. 10 is a schematic view of an automated teller machine provided with a second variant of a camera system according to the principle of FIG. 2 and a display screen that is divided into two areas.

The invention will be elucidated below on the basis of an example of an automated teller machine 1 (see FIGS. 3-10). The machine in question is an apparatus which automatically verifies a user's authority to withdraw cash without the intervention of desk staff and which dispenses bank notes or coins when the user's authority is confirmed. Within the context of verifying the user's authority, the user is invited to input confidential data, for example a four-digit PIN code, one or more times. The user inputs such data by means of a keypad 2. The automated teller machine 1, or a remote system connected thereto, uses said data for making a comparison with known, likewise secret data. The system described below is also used in other systems that automatically carry out an authority verification on the basis of data input by a user. Examples include point-of-sale terminals, service terminals for consulting and/or changing account data, etc.

The keypad 2 is an example of an input device by means of which the user can input data that are to be kept secret. In another example, use is made of a different type of input device, which is characterised in that the inputting of data can be observed by a person present in the immediate vicinity of the user. The device may be a touch screen or a screen in combination with a cursor control device.

All variants of the system described herein comprise at least a first camera 3 (FIGS. 1 and 2). The first camera 3 is directed at an area located at least partially behind the user, at least when the user faces the input device and is positioned at such a distance therefrom that he is able to input data therewith. Said area is thus an area located outside the area that can be directly observed by the user.

Images recorded by the first camera 3 are displayed on a screen 4 (FIGS. 1 and 2). In one variant, the image is first processed, so that possibly only part of the recorded image will be displayed. In a first variant, the screen 4 is an active light-emitting screen, for example an LCD screen or a cathode ray tube. In another variant, the system comprises a device for displaying images recorded by the camera 3 by projecting the recorded images on a reflective screen 4

The entire system is so arranged that the screen 4, with the image recorded by the first camera 3 displayed thereon, is visible the moment the system enables the user to input data for verifying the user's transaction authority. Preferably, images recorded by the camera 3 are displayed on the screen 4 in real time, possibly in quasi-real time. In an advantageous embodiment, the displayed image also shows the current recording time and date. This enables the user to ensure that the images are live images. The user is more aware of his surrounding while inputting the confidential data and better able to assess whether the situation is unsafe or possibly threatens to become unsafe.

In addition to being presented to the user for inspection, images recorded by one or more cameras are also communicated to a central station 5 at a location remote from the automated teller machine 1. In the variant that is shown in FIG. 1, images recorded by a second camera 6 are separately transmitted to the central station 5. Said images are not displayed on the screen 4, but they may be images of the same area, of course. In a second variant (FIGS. 2-10), the images from the first camera 3 are at least partially displayed on the screen 4 as well as communicated to the central station 5 at a location remote from the transaction system.

FIG. 3 shows an automated teller machine 1 installed in a recess in a wall 7. A camera 8 is mounted on or in the wall 7. The camera 8 functions as the first camera 3. Like the examples shown in FIGS. 4-10, the automated teller machine 1 furthermore comprises a reading screen 9. The transaction system of which the automated teller machine forms part is arranged for displaying bank information and/or information relating to the progress of the transaction on the reading screen 9. As usual, the automated teller machine is furthermore provided with a card slot 10 for a bank card comprising a magnetic strip or chip, in which for example the PIN code or corresponding data is stored. The automated teller machine furthermore comprises a money dispensing slot 11 for the money to be withdrawn and a receipt dispensing slot 12.

In the example of FIG. 3, a further camera (not shown in FIG. 3) may be provided in addition to the camera 8, which further camera may or may not be invisibly integrated in a frame 13 of the automated teller machine 1. The same applies with regard to the examples shown in FIGS. 5, 7 and 9. In the examples shown in FIGS. 4, 6, 8 and 10, a camera 14 which is integrated in the frame 13 is used for showing the area behind the user. The advantage of this is that no separate, additional measures are required for protecting the camera 14 against vandalism, which renders the variant of FIG. 4 more efficient than that of FIG. 3. In both examples a screen 15 is present in or on the wall 7 beside the automated teller machine, and the images recorded by the cameras 8 and/or 10 are displayed on said screen 15. It is relatively easy to adapt the surrounding of an existing automated teller machine 1 for use of the system described herein.

In the variants that are shown in FIGS. 5-6, a second screen 16 is mounted in a panel 17 of the automated teller machine 1 beside the reading screen 9. Said panel is the panel 17 in which also the reading screen 9 is integrated. As a result, the second screen 16 will automatically fall within the user's field of vision while he is carrying out the transaction. In the variants that are shown in FIGS. 7-8, the second screen 16 is mounted in a side panel 18 of the automated teller machine 1, which joins the frame 13 and which is disposed at an angle with respect thereto.

In the variants that are shown in FIGS. 9 and 10, images recorded by the cameras 8 and/or 14 are displayed within a first area 19 of the reading screen 9, and data relating to the transaction are displayed within a second area 20. Said images may for example be picture elements displayed in response to the data input by the user. Examples are coloured blocks or asterisks shown in a number corresponding to the number of digits of a PIN code input by means of the keypad 2.

In the variants that are shown in FIGS. 9 and 10, the existing structure of the existing automated teller machine 1 is utilised in an efficient manner. A separate display screen is no longer needed, because the images recorded by a camera 8, 14 directed at the area behind the user are at least partially displayed on the reading screen 9 whilst data relating to a transaction are simultaneously displayed on the same reading screen 9. In addition, the user will be able to keep his eyes focused on one and the same reading screen 9 during the entire time a transaction is in progress.

This latter effect occurs even more strongly in a variant (not shown) in which images recorded by a camera directed at the area are displayed as a background image on a display screen and data relating to the transaction are simultaneously displayed on the foreground, superimposed over said background image. To implement this variant, the automated teller machine 1 is fitted with a picture-in-picture display unit similar to that which is known from television technology.

The invention is not restricted to the embodiments as described above, which can be modified without departing from the scope of the invention as defined in the appended claims. For example, a system as described above can be realised by removing a part of the panel 17 disposed beside the reading screen 9 in order to mount the second screen 16 in said part. Said part is preferably the part on which previously information regarding allowed bank card types was displayed. As a result, existing automated teller machines need not be replaced by automated teller machines of larger dimensions.

1. A transaction system comprising
an input device for inputting of data by a user, and
at least one screen which is visible during use of the input device, said system being arranged for displaying an area located at least partially behind a user facing the input device on the screen at least during use of the input device, characterized in that the transaction system comprises at least one camera directed at said area and a device for displaying images recorded by at least one of the cameras at least partially on the screen.

2. A system according to claim 1, comprising a device for communicating images recorded by at least one of the cameras directed at the area to a central station present at a location remote from the system.

3. A system according to claim 2, wherein the system is arranged both for displaying images recorded by a camera directed at said area at least partially on the screen and for communicating said images to said remote central station.

4. A system according to claim 1, wherein the system is arranged for displaying images recorded by a camera directed at said area at least partially on a display screen and at the same time displaying data relating to a transaction on the same display screen.

5. A system according to claim 4, wherein the system is arranged for displaying images recorded by a camera directed at the area on the display screen as a background image and at the same time displaying data relating to the transactions on the foreground, superimposed over the background image.

6. A system according to claim 1, wherein at least one of the cameras directed at said area is integrated in an automated teller machine, preferably an automated teller machine that is mounted in a wall.

7. A method for verifying a user's transaction authority, comprising the steps of
providing an input device for inputting data for verifying a user's authority, and
enabling the user to observe an area located at least partially behind the user on a screen at least during inputting of data, characterised by
the recording of at least one image of said area by means of at least one camera and displaying the image recorded by the camera on the screen.

8. An automated teller machine provided with a transaction system according to claim 1.

9. An automated teller machine according to claim 8, wherein the screen is integrated in a panel of the automated teller machine.
